(19) United States
(12) Patent Application Publication
(10) Pub. No.: US 2019/0345338 A1
(43) Pub. Date: Nov. 14, 2019

(54) SURFACE MODIFYING AGENT FORMULATION

(71) Applicants: Robert N. Clausi, Oakville, Ontario (CA); Salvatore Diloreto, Ancaster, Ontario (CA)

(72) Inventors: Robert N. Clausi, Oakville, Ontario (CA); Salvatore Diloreto, Ancaster, Ontario (CA)

(21) Appl. No.: 16/331,361

(22) PCT Filed: Sep. 8, 2017
(86) PCT No.: PCT/CA2017/051055

§ 371 Date: Mar. 7, 2019

Related U.S. Application Data
(60) Provisional application No. 62/385,538, filed on Sep. 9, 2016.

(51) Int. Cl. C08L 97/02; C08G 18/76; B27N 3/00; B27N 3/02; B27N 3/04; B27N 3/20; B27N 1/02

(52) U.S. Cl. CPC C08L 97/02; C08G 18/7664; B27N 3/002; B27N 1/0218; B27N 3/04; B27N 3/203; B27N 3/02

(57) ABSTRACT

The present invention describes the production of wood panel boards, or the like, in which a surface modifying agent is mixed with a polyol to prepare a stable surface modifying agent polyol composition. The resultant composition is reacted with an isocyanate, and in particular, a polymeric di-isocyanate resin, in the presence of wood chips, fibers or the like, for the production of lignocellulosic based panels, such as oriented strand board (OSB), MDF, HDF and particle board panel products. In use, the surface modifying agent polyol composition is mixed with the polymeric di-isocyanate resin and the resultant mixture is applied to a lignocel-lulosic material, such as wood chips or fibers, immediately prior to hot pressing of the mixture to produce the panels. Sticking of the panels to the metal press belts or press plates typically used during production, is reduced or eliminated.

### FIELD OF THE INVENTION

The present invention relates to the field of lignocellulosic panel production, and in particular, the production of particle board or fibreboard panels utilizing a polyurethane binding resin. The present invention is directed to resin formulations which permit the panels to be easily removed from the production press.

### BACKGROUND OF THE INVENTION

Oriented Strand Board (OSB), Particleboard, Medium Density Fibreboard (MDF), High Density Fibreboard (HDF), Plywood, and other lignocellulosic panel products are made from wood fibres or wood chips which are pressed together under pressure, and at elevated temperatures, to produce an essentially rigid panel product. A number of different binding resins are employed during pressing, to hold the panel together as the resins cure. Typical binding resins include urea formaldehyde, melamine-urea formaldehyde, phenol formaldehyde and polymeric di-isocyanate (PMDI) resins. To a varying degree, all resins create sticking issues during pressing of the panel products and typical production processes require the spraying of the press platens with wax release agents and the like so that the panels can be easily removed from the mould. There are also wax emulsions, and the like, that may be added to the resin systems in order to improve the surface release characteristics of the pressed panel.

It is known in the art, that manufacturing of oriented strand board, MDF, HDF and other lignocellulosic panel products using a polymeric di-isocyanate (PMDI) resin system can produce higher quality panels that exhibit good mechanical properties while being able to provide panels that have no added formaldehyde. However, PMDI systems have the inherent disadvantage that they cause severe sticking of the treated lignocellulosic material (e.g. the fibres or chips) to the hot metal surfaces in which it comes into contact with during the hot pressing operation. Often, the final panel product is damaged in removing it from the press and/or a great deal of time is required to remove that pressed cellulosic material from the hot surfaces of the press parts.

Conventional release agents such as oils, wax polishes, metallic soaps, silicones and polytetrafluoroethylene have been applied externally on the metal press surfaces, but have proven to be unsatisfactory.

Other attempts to overcome this adhesion problem for PMDI include applying a release agent which catalyzes the formation of isocyanurate from isocyanates (see U.S. Pat. No. 3,870,665 to Diehr et al.). The release agent catalysis materials include strong bases such as quaternary ammonium hydroxides, various amines, or certain metal salts of carboxylic acids such as sodium acetate and the like.

Other approaches include the use of mould release agents such as zinc or tin(bis)maleates, as described in PCT patent publication No. WO95/02619, in order to produce a storage-stable, one component formulation. The problem with these systems is their limited solubility in the PMDI composition itself leading to unsatisfactory release performance.

In order to solubilise the metal maleates, the polyisocyanate composition can also include compatibilising agents, such as the reaction product of an organic mono- or polyfunctional isocyanate and a compound such as decyl and stearyl acetoacetate and bis-decyl malonate, and the like, as described in PCT patent publication No. WO95/13323.

Canadian patent No. 1176778 also describes the use of stearates, and zinc stearate in particular, as a release agent in the production of hot-pressed wood composites, including particleboard and waferboard. However, the polyisocyanate used in that patent is mixed with high levels of hydrocarbon oils that are non-reactive with the polyisocyanate, and are selected from petroleum based oils such as paraffin oil, mineral oil and the like. Also, excessively high levels of the stearates are merely mixed directly into the mixture of the polyisocyanate and hydrocarbon oil, immediately prior to applying the blend to the wood chips used in the production of the wood composite. While some beneficial results were observed, use of this material in a commercial approach is not practical.

As such, the release performance of lignocellulosic bodies bound with polyisocyanate compositions containing the above described release agents, is still not satisfactory.

To overcome these difficulties, it would be advantageous to provide a composition for use with a polymeric di-isocyanate (PMDI) formulation, to produce a PMDI composition that yields satisfactory release of the lignocellulosic bodies from the press surfaces, without detrimentally affecting the other board properties.

It would be even more advantageous to provide a liquid metallic carboxylate release agent formulation which is storage stable.

It would be even still more advantageous to provide a system wherein the isocyanate and the composition are capable of being pre-blended, preferably in-line, essentially immediately prior to spraying the polymeric di-isocyanate and composition on to the wood chips or wood fibres. Preferably, this would be done just prior to production of the lignocellulosic panels, in a manner consistent with the production of lignocellulosic panels, as is currently practised, without the need for any significant modification of this process.

These and other advantages inherent therein, are provided by the composition and methods of the present invention, as provided herein.

### SUMMARY OF THE INVENTION

An exemplary implementation of the present invention features a surface modifying agent which agent is blended with a polyol to produce a surface modifying polyol composition.

The surface modifying polyol composition is preferably storage stable, and is suitable for mixing with an isocyanate resin, and in particular, a polymeric di-isocyanate (PMDI) resin. Mixing with the isocyanate resin is preferably done essentially immediately prior to being sprayed onto a mat of, or collection of, loose lignocellulosic bodies, in general accordance with current lignocellulosic panel production processes.

Accordingly, in a first aspect, the present invention provides a surface modifying agent polyol composition for use in the product of a polyurethane based lignocellulosic panel, comprising a mixture of a polyol, and a surface modifying agent.

Preferred surface modifying agents for inclusion in the surface modifying polyol composition include carboxylates, and in particular, metal carboxylate compounds having the general formula (I), namely:

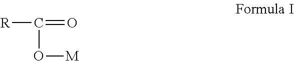

wherein metal (M) is a metal selected from the group consisting of Group 1A, 2A, 4B, 4A, 1B, 2B and 8 of the Periodic Table of Elements, and R is preferably a saturated or unsaturated hydrocarbon, and preferably, a saturated or unsaturated aliphatic hydrocarbon. More preferably, R is an aliphatic hydrocarbon radical having from 1 to 60 carbon atoms, more preferably from 4 to 40 carbon atoms, and most preferably, from 10 to 25 carbon atoms.

Further, R is preferably an aliphatic hydrocarbon radical which can be straight or branched chain alkyl or cycloalkyl radical, that can include unsaturated groups. Still further, the inclusion of other atoms such as silicon, or the like, in their chain, is not excluded. R can also be, or include, a primary, secondary or tertiary alcohol; preferably having a hydroxyl functionality of between 1-5. This later approach would allow the surface modifying agent to react with the isocyanate component.

In a most preferred embodiment, R is the residual of an organic acid, so as to form a metal carboxylate. Thus, the preferred surface modifying agent used in the practice of the present invention, is the reaction product of a metal-containing material together with an organic acid. Preferred organic acids include carboxylic acids such as, for example, Stearic acid, Lauric acid, Myristic acid, Palmitic acid, Stearic acid, Oleic acid, Ricinoleic Acid, Linoleic acid, Linolenic acid, Hydroxypentanoic acid, Dihydroxybutanoic acid, Dihyroxybenzoic acid, Glycolic acid, Lactic acid, Tartaric acid, Citric acid, Malic acid and the like, with Stearic acid being one particularly preferred material.

The preferred metallic carboxylates of the present invention are preferably made by the direct reaction of these carboxylic acids with metal-containing salts, such as metal sulphates, oxides, hydroxides, and carbonates.

Preferably the metal component “M” of Formula 1, or more preferably, of the metal carboxylate is sodium, potassium, magnesium, lithium, calcium, titanium, tin, lead, copper, silver, zinc, cadmium, iron, cobalt, nickel, or platinum, with zinc being the most preferred metal.

As such, in the practice of the present invention, the preferred metal carboxylate compounds used are zinc stearate, magnesium stearate, lithium stearate, calcium stearate and cobalt stearate, with zinc stearate being a particularly preferred material.

The level of the surface modifying agent, and preferably, a metal carboxylate, in the surface modifying polyol composition is between 10 and 90% by weight of the total weight of the metal carboxylate and polyol. More preferably, the level of the metal carboxylate is between 25 and 75%, and still more preferably, between 40 and 60%, of the total weight of the metal carboxylate and polyol blend. One particularly preferred blend is a mixture of equal parts, by weight, of the metal carboxylate and the polyol.

The polyol portion of the stable surface modifying polyol composition can be any suitable polyol, and can include aliphatic or aromatic polyols, including polyester, polyether, and caprolactone-based polyols. The polyols preferably are liquid at room temperature, and preferably have molecular weights of between 250 and 8000, more preferably between 400 and 4500, and most preferably, between 500 and 2000. The polyol is reactive with the isocyanate, and preferably, the polyol has an isocyanate reaction functionality of at least 2, and more preferably, between 2 and 4. Preferred polyols include materials such as glycerol, 3-(2-hydroxyethoxy)-1,2-propanediol, 3-(2-hydroxypropoxy)-1,2-propanediol, 2,4-dimethyl-2-(2-hydroxyethoxy)-methylpentanediol-1,5, 1,2,6-hexanetriol, 1,1,1,-trimethylolpropane, or the like, or can be made by any suitable production method which would typically and preferably involve reacting ethylene oxide (EO), propylene oxide (PO) or butylene oxide (BO) with materials such as 1,1,1-tris[(2-hydroxyethoxy)methyl]ethane, 1,1,1,-tris-[(2-hydroxypropoxy)methyl]propane, triethanolamine, triisopropanolamine, pyrogallol or phloroglucinol, in order to form a chain-extended polyol.

One example of a suitable chain-extended polyol is the polyether triol sold under the trade name XD 1421™, which is made by the Dow Chemical Company. It has a molecular weight of around 4900, and is composed of a ratio of three oxyethylene (ethylene oxide) units randomly copolymerized per one unit of oxypropylene (propylene oxide). It has a hydroxy content of 0.61 meq. OH/g. Another example of a material which is commercially available is Pluracol V-7™ made by BASF Wyandotte which is a high molecular weight liquid polyoxyalkylene polyol. Other polyols which might be used are polyether polyols such as Pluracol 492™ from BASF, having a molecular weight of 2000. Alternatively, saturated polyester polyols such as Desmophen 2500™ from Bayer, having a molecular weight of 1000 might also be used.

Further, other isocyanate-reactive oils, including castor oils such as DB castor oil or regular commercial grades of castor oil, having a variety of fatty acids, might also be used. Additionally, Soy-based polyols, or polybutadiene resins, such as Poly BD R45T™, available from Sartomer, can be used. In general though, a wide variety of polyols might be used, provided that they are storage stable when blended with the surface modifying agent, while still being reactive with the isocyanate component.

Further, combinations of various polyols, or types of polyols, or mixtures thereof and therebetween, might also be used. For example, one preferred blend is a blend of a polypropylene oxide-based polyol and castor oil.

Preferred isocyanate binder resins to be used with the present invention are those wherein the isocyanate is an aromatic diisocyanate or a polyisocyanate of preferably higher functionality such as a pure diphenylmethane diisocyanate or mixture of methylene bridged polyphenyl polyisocyanates containing diisocyanates, triisocyanates and preferably higher functionality polyisocyanates.

Polymeric mixtures of methylene bridged polyphenyl polyisocyanates containing diisocyanate, triisocyanate and higher functionality polyisocyanates are particularly preferred in the practice of the present invention, and are typically referred to as polymeric MDI or PMDI. The MDI or PMDI preferably has an isocyanate content of between 12%-40%, more preferably between 20%-35% and still more preferably between 29%-33%. They also typically have a functionality range of between 2-4, and most preferably a functionally of between 2.5 and 2.9. Suitable products include isocyanates such as like Huntsman Rubinate M™, Covestro Mondur MR Light™, BASF Lupranate M™, and Wanhua PM200™, all of which are commercially available.

Preferably the PMDI is liquid at room temperature to facilitate spraying and mixing of the isocyanate with the polyol mixture, and the lignocelluosic material. However, the PMDI might be heated to liquefy the material, for spraying.

In one preferred exemplification of the present invention, the metallic carboxylate, as a preferred surface modifying agent, is first blended with the polyol component to produce a stable surface modifying agent polyol composition. The composition, or blend, is typically an opaque solution, wherein the surface modifying agent is preferably dissolved in, at least partially dissolved in, or is completely dispersed within, the polyol component.

The mixture of the isocyanate-containing resin, and the surface modifying agent polyol composition, in the final resin system is such that the level of isocyanate resin typically ranges from about 98% isocyanate resin, to about 50% isocyanate resin, by weight. More preferably, the level of isocyanate resin is between 95 and 60% by weight, and still more preferably, the amount of isocyanate resin used in the final resin, in combination with the surface modifying agent polyol composition, is between 90 and 65%, by weight of the final resin.

In other words, the amount of the blend of the surface modifying agent and polyol, in the final resin system when mixed with the isocyanate resin, is preferably between 2 and 50% by weight of the final resin system. More preferably, the level of surface modifying agent polyol composition is between 5 and 40%, and still more preferably, between 10 and 35% by weight of the final resin system.

In a preferred embodiment, the final resin composition comprises a blend of about 65 to 80% isocyanate and 20 to 35% of the surface modifying agent polyol composition.

The surface modifying agent polyol composition, such as the aforementioned metallic carboxylate and polyol mixture, may also comprise an added surfactant to provide improved wetting. Alternatively, or additionally, an inert diluent may be added to the composition to also provide improved wetting of the surface modifying agent in the polyol.

Preferably, the surfactant is amphiphilic having both hydrophobic and hydrophilic ends, and preferred surfactants include surfactants such as Huntsman Ecoteric 7000™, and the like.

The surfactant is typically added in amounts of 0-50% (parts by weight) of the mixture of the surface modifying agent and the polyol, and preferably 30-40% (parts by weight) of the surface modifying agent and polyol composition.

Diluents are typically added in amounts of from 0 to 30 parts by weight per 100 parts by weight of polyol and preferably in amounts of from 5 to 15 parts by weight per 100 parts by weight of the surface modifying agent and polyol blend.

Suitable diluents include materials, such as phthalates, aliphatic carboxylates, fatty acid esters, or oil products, such as Linseed oil and Soybean oil, although other materials might also be used as diluents.

The surface modifying agent may also be dissolved in, or include, a suitable solvent prior to being mixed with the polyol. Suitable solvents include solvents such as glycol ether acetates, ethyl acetate and acetone and in particular, solvents such as dimethyl maleate esters. Preferably, the surface modifying agent is dispersed or dissolved in the solvent, prior to being mixed with the polyol. The amount of solvent, when used, is preferably between 1- and 50% (by weight), and more preferably, between 5 and 20% (by weight) of the weight of the surface modifying agent material used.

The final resin system provides a polyurethane resin system composition which may further comprise conventional additives like flame retardants, lignocellulosic preserving agents, fungicides, waxes, sizing agents, fillers, and other binders like formaldehyde condensate adhesive resins. These are typically added at levels of between 0-10% by weight of the total polyurethane resin binding system.

Using the products of the present invention, it has been found that the final polyurethane resin system, and preferably, a polymeric di-isocyanate, together with a metallic carboxylate and polyol composition, according to the present invention, are extremely effective in minimizing unwanted adhesion by a sprayed, treated lignocellulosic material, to caul plates, press plates and other surfaces with which the heated lignocellulosic material may come into contact. Their release performance and storage stability is improved compared to prior art one component, pre-mixed polymeric di-isocyanate compositions.

In use, the stable surface modifying polyol composition is mixed with the isocyanate component immediately prior to being sprayed onto a mat of lignocellulosic material (e.g. wood chips, shavings, fibres or the like, or blends thereof). The sprayed lignocellulosic material mat is then preferably pressed between caul plates, press plates or other such surfaces, while being heated, in order to compress the mat to its final thickness, and effect curing of the isocyanate and, inter alia, the polyol components.

As such, in a further aspect, the present invention also provides a method for the production of a lignocellulosic panel comprising:

mixing a surface modifying agent, as previously described, with a polyol capable of reacting with an isocyanate resin, to produce a stable surface modifying agent polyol composition;

preparing a mat of a lignocellulosic material;

mixing said stable modifying agent polyol composition with an isocyanate, and preferably with a polymeric di-isocyanate, to produce a final resin mixture, and spraying said final resin mixture onto said mat of lignocellulosic material;

compressing the sprayed mat of lignocellulosic material in a press, while heating, so as to form a cured lignocellulosic panel; and

removing said cured lignocellulosic panel from said press.

The reaction materials, and in particular, the surface modifying agent, the polyol, and the isocyanate used in this method, are the same materials described hereinabove.

In more detail, in a preferred embodiment, the lignocellulosic mat is typically prepared by bringing the lignocellulosic bodies into contact with the isocyanate and surface modifying agent polyol composition by means of mixing, spraying and/or spreading the isocyanate and surface modifying agent polyol composition with, or onto the lignocellulosic bodies in order to form a mat, and then pressing the mat. Preferably this is accomplished by hot-pressing the mat at 150° C. to 220° C., and at pressures of between 1 to 8, and more preferably, between 2 to 6 MPa specific pressure.

In the press, the resin mixture reacts, and thus forms the desired panel. The properties of the panel are similar with panels produced using other known panel production methods, but is easily removed from the press. It should also be noted that under these conditions, the resin mixture is preferably free of gas bubbles, and thus, the resin, or panel, is not foamed in any fashion. Accordingly, a non-foamed, rigid panel product equivalent to known panels, is preferably produced.

In a particularly preferred embodiment, the process is used in the production of oriented strand board (otherwise known as wafer board) production. As such, for OSB panels, the lignocellulosic material, the PMDI (as isocyanate), and the mixture of the metal carboxylate (as surface modifying agent) and polyol composition, may be conveniently mixed in a mixer prior to use, or mixed in a spray gun, essentially immediately prior to spraying the PMDI and metal carboxylate and polyol composition mixture onto the lignocellulosic material. In this later case, mixing of the components is accomplished by mixing in the spray gun immediately prior to spraying.

The phrase “immediately prior” typically will mean time periods of less than 5 seconds, and commonly, less than 2 seconds prior to spraying. However, depending on the materials used, the phrase “immediately prior” can include time periods of up to, for example 5 minutes, and even up to 20 to 30 minutes.

The lignocellulosic material after treatment with the PMDI and metal carboxylate and polyol composition is then typically placed on caul plates made of aluminum or steel which serve to carry the lignocelluosic material “furnish” into the press where it is compressed to the desired extent usually at a temperature between 150° C. and 220° C.

More detailed descriptions of methods of manufacturing oriented strand board and similar products based on lignocellulosic material are available in the prior art. Preferably, the techniques and equipment conventionally used therein, can be used in the present process, or can be easily adapted for use with the polyurethane and surface modifying agent combination, of the present invention.

Further, it should be noted that while the process of the present invention is particularly suitable for the manufacture of oriented strand board, and will be largely used for such manufacture, the process can also be used in the manufacture of other lignocellulosic panel products including, for example, medium density fiberboard, high density fibreboard, particle board (also known as chipboard), plywood, and the like.

A variety of lignocellulosic materials can be used. These include, wood strands, wood chips, wood fibers, shavings, veneers, wood wool, cork, bark, sawdust and like waste products of the wood working industry, as well as other materials having a lignocellulosic basis such as paper, bagasse, straw, flax, sisal, hemp, rushes, reeds, rice hulls, husks, grass, nutshells and the like. Additionally, these materials may be mixed with, typically in amounts of up to 10% by weight of the lignocellulosic material, with other particulate or fibrous materials, including, for example, mineral fillers, glass fibres, mica, rubber, and textile waste such as plastic fibers and fabrics, and the like.

Further, the process of the present invention is used with wood chips or wood fibres, and these can be sourced from any type of wood. A particularly preferred wood is Aspen wood, however, other types of wood such as Pine or Spruce wood, or hardwoods, such as Maple or Oak, are not excluded. The lignocellulosic material preferably has a moisture content of less than 15%, more preferably, less than 10%, and still more preferably, less than 7.5%, by weight.

When the isocyanate resin, and preferably the PMDI resin, is applied to the lignocellulosic material, the weight ratio of isocyanate resin to the lignocellulosic material will vary depending on the bulk density of the lignocellulosic material employed. Therefore, the isocyanate resin is preferably applied to the lignocellulosic material in such amounts so as to provide a weight ratio of isocyanate resin to lignocellulosic material in the range of 0.1:100 to 20:100, preferably in the range of 1.0:100 to 10:100, and most preferably, in the range of 2:100 to 6:100. It has been noted though, that where production facilities use both PMDI-based and Melamine Formaldehyde (MF)—based binders with the same press equipment, it may be helpful at the start of a manufacturing run with PMDI, but not essential, to condition the press plates by spraying their surfaces with an external release agent. The conditioned press may then be used many times in the process of the invention using PMDI-based materials, without further treatment. These additional external release agents can be any suitable release agents known in the prior art, and can include waxes and the like, provided they are compatible with the polyurethane based systems, and in particular, the PMDI-based systems of the present invention.

If desired, up to 50% of other conventional binding agents, such as formaldehyde condensate adhesive resins, may be used in conjunction with the polyurethane resin and surface modifying agent polyol composition mixtures of the present invention.

Further, the process of the present invention might also be used to prepare various moulded bodies that can also be prepared in a heated press. For example, it has been found that the lignocellulosic sheets and panels, and the moulded bodies produced from the polyurethane resin with surface modifying agent polyol composition, and in particular, the PMDI and metal carboxylate polyol compositions, of the present invention, have excellent mechanical properties and they may be used in any of the situations where such sheets, panels, articles and other moulded products, are customarily used.

As such, in a further aspect, the present invention also provides a method for the production of a lignocellulosic body comprising:

preparing an isocyanate-containing mixture as described hereinabove, as a final resin mixture;

spraying said final resin mixture onto a lignocellulosic material so as to produce a sprayed mat of lignocellulosic material;

compressing said sprayed mat of lignocellulosic material in a mould, while heating, so as to form a cured lignocellulosic body; and

removing said cured lignocellulosic panel from said mould.

### BRIEF DESCRIPTION OF THE DRAWINGS

Embodiments of this invention will now be described by way of example only in association with the accompanying drawings in which:

FIG. 1 is a partial cut-away, side view of a collection of wood chips ready being coated with the final resin system, in a mixer;

FIG. 2 is a side view of the components of a pressing assembly of the type used in the examples; and

FIG. 3 is a side view of an OSB panel, after pressing.

### DETAILED DESCRIPTION OF THE PREFERRED EMBODIMENTS

The novel features which are believed to be characteristic of the present invention, as to its structure, organization, use and method of operation, together with further objectives and advantages thereof, will be better understood from the following examples. Where appropriate, reference is made to the drawings in which a presently preferred embodiment of the invention will also be illustrated by way of example only. In the drawings, like reference numerals depict like elements.

It is expressly understood, however, that the drawings are for the purpose of illustration and description only and are not intended as a definition of the limits of the invention. Also, unless otherwise specifically noted, all of the features described herein may be combined with any of the above aspects, in any combination.

### EXAMPLES

The features of the present invention are now illustrated by the following, non-limiting examples.

### Example 1

### Preparation of the Metal Carboxylate:

By way of example only, sample metal carboxylate materials of use in the practice of the present invention, were prepared according to the following techniques:

(a) 1 mol of zinc sulphate was dissolved in 12.5 L of water at 30° C., and this was reacted with 2 mols of sodium stearate, dissolved in 12.5 L of water, at 70° C. The reaction temperature was held at 70° C. for 4 hours. The reaction precipitate was collected and was filtered under vacuum. The precipitate was washed twice with 12 L of deionized water. The wet cake was then dried in a vacuum oven at 100° C. for 4 hours to produce a dry product.

(b) 1 mol of zinc sulphate is dissolved in water is reacted with 2 mols of sodium ricinoleate, under constant agitation, to produce zinc ricinoleate as the metal carboxylate. The zinc ricinoleate precipitate is filtered and then washed with distilled water and allowed to dry in a desiccant dryer.

(c) 1 mol of zinc sulphate is dissolved in water is reacted with 2 mols of sodium hydroxypentanoate, under constant agitation, to produce zinc hydroxypentanoate as the metal carboxylate. The zinc hydroxypentanoate precipitate is filtered and then washed with distilled water and allowed to dry in a desiccant dryer.

(d) 1 mol of zinc sulphate is dissolved in water is reacted with 2 mols of sodium 2,3-dihydroxybutanoate, under constant agitation, to produce zinc dihydroxybutanoate as the metal carboxylate. The zinc dihydroxybutanoate precipitate is filtered and then washed with distilled water and allowed to dry in a desiccant dryer.

(e) 1 mol of zinc sulphate is dissolved in water is reacted with 2 mols of sodium 2,3-dihydroxybenzoate, under constant agitation, to produce zinc dihydroxybenzoate as the metal carboxylate. The zinc dihydroxybenzoate precipitate is filtered and then washed with distilled water and allowed to dry in a desiccant dryer.

(f) 1 mol of zinc sulphate is dissolved in water is reacted with 2 mols of sodium 3-hydroxypentanoate under constant agitation to produce zinc hydroxypentanoate as the metal carboxylate. The zinc hydroxypentanoate precipitate is filtered and then washed with distilled water and allowed to dry in a desiccant dryer.

Other metal carboxylates were prepared, using similar reaction techniques, starting with calcium sulphate, magnesium sulphate and sodium sulphate. The resulting metallic carboxylates were the calcium, magnesium and sodium analogues to the zinc carboxylates listed in examples 1(a) to 1(f).

Blending with Polyol:

The resultant metallic carboxylates from examples 1(a) to 1(f), were blended with various polyols, including polyether, polyester, polycaprolactone, polybutadiene, castor or soybean oils, or with some of the polyols previously mentioned, in order to produce various metallic carboxylate and polyol blends. Where needed, the metallic carboxylate and polyol blends were shear mixed. The resulting blends produced free flowing liquid materials with no visible particles in the metal carboxylate and polyol composition.

First, the metal carboxylate, as the surface modifying agent, in the total surface modifying polyol composition was used at an amount of either 25 or 75% by weight, of the total weight. A storage stable composition was obtained. Blends were also made at a weight ratio of 2 parts polyol to 1 part metal carboxylate (66% polyol), and again, a storage stable composition was obtained. Finally, mixtures of 1 part polyol to 1 part metal carboxylate were also prepared (50% polyol), and these blends were also storage stable.

By storage stable is meant that the composition remained as a liquefied material for more than 24 hours, with minimal thickening or settling of the metal carboxylate.

Reaction with Isocyanate:

Various metal carboxylate and polyol blend compositions described hereinabove, were blended with various isocyanate materials, and in particular, the preferred PMDI resins, previously described.

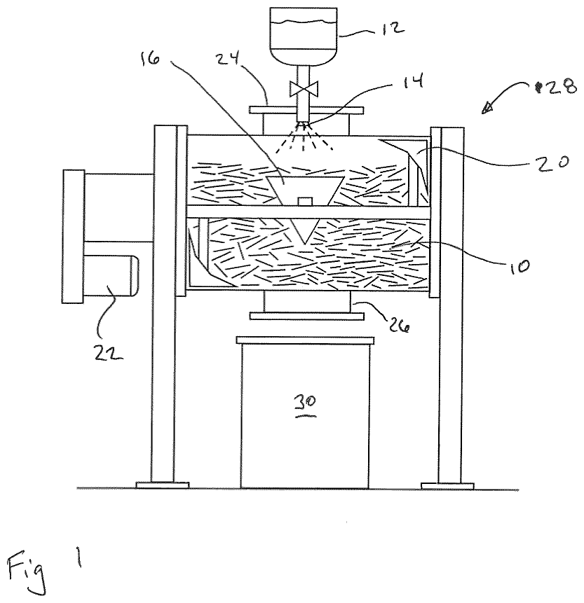

Generally, the resins were pre-mixed in a ratio of 1 part (by weight) of the metal carboxylate and polyol blend composition, with 6 parts (by weight) PMDI resin. The isocyanate-containing blended composition was added to aspen wood chips at a ratio of 7 parts by weight of the blended resin composition (e.g. 6 parts PMDI and 1 part of the surface modifying agent polyol composition), to 100 parts by weight wood chips, in the manner as shown in FIG. 1.

In FIG. 1, a loose collection of aspen wood chips 10 are shown in the mixing drum 20 (partially cutaway) of a Lodige™ plough mixer 28. In FIG. 1, wood chips 10 are being coated with an isocyanate-containing blended resin composition, stored in tank 12 which is being sprayed onto the wood chips, by spray nozzle 14. The resin composition is a mixture of a isocyanate resin and the surface modifying agent polyol which are mixed together immediately prior to use. For this “batch” operation, the isocyanate and surface modifying agent can be pre-mixed, and transferred to tank 12, and then sprayed onto wood chips 12 using spray nozzle 14. For continuous operation, the isocyanate and polyol mixture would be blended immediately prior to spraying.

The collection of resin-coated aspen wood chips 10 is mixed by movement of mixing blade 16, inside of drum 20. Mixing blade 16 is moved using motor 22.

Wood chips 10 are added to drum 20 using top opening 24, and after mixing, are removed from drum 20 using bottom opening 26, where they are collected in bucket 30. Before the resin system can cure completely, the wood chips in bucket 30 are transferred to the pressing operation, as described hereinbelow.

It should be noted that the PMDI resin to wood chip ratio, equal to 6 parts of PMDI to 100 parts of wood chips was used to illustrate a high polyurethane concentration and its effect on sticking. As such, the amount of isocyanate in the mixture of the surface modifying agent polyol composition was approximately 86% by weight. The amount of wood chips in the final mixture is approximately 93%, by weight.

It should also be noted that in the prior art, normal concentrations of PMDI polyurethane resins to wood chips would be in the range of 2 to 4 parts of PMDI, to 100 parts by weight of wood chips. This ratio results in much lower levels of the isocyanate being used in the pressing operation, and as such, it would be expected that there would be a reduction in the degree of sticking observed. As such, the examples described hereinbelow are generally being conducted under more severe conditions.

After spraying the wood chips, each mixture was blended in the Lodige plough blender for three minutes to thoroughly coat the wood chips, prior to pressing.

### Example2

### Pressed Panels

3 kg of air dry Aspen chips with a moisture content of approximately 6.5% were blended with a mixture of 180 g of HUNTSMAN Rubinate M PMDI and 30 g of a pre-mixed blend of 15 grams zinc stearate and 15 grams of Pluracol 492, by air atomized spray application in a 60 litre Lodige plough blender, as described hereinabove with reference to FIG. 1.

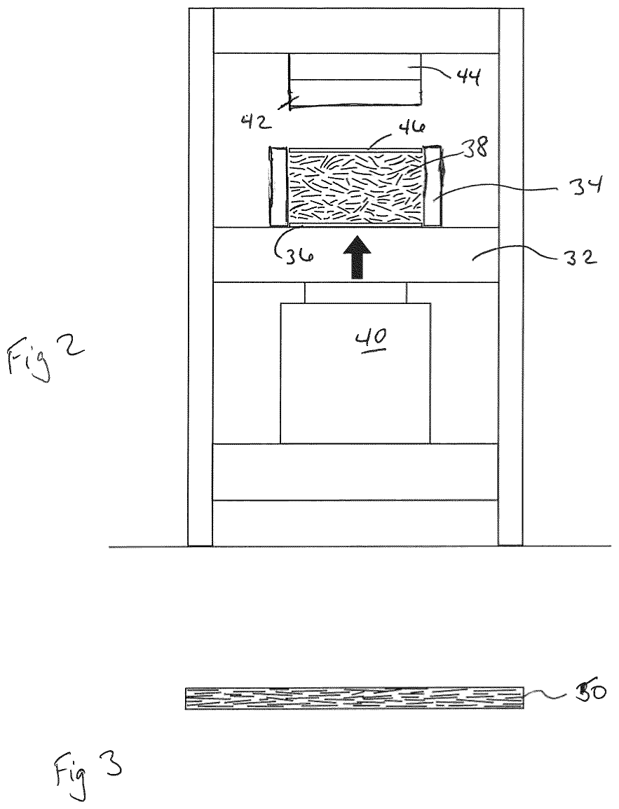

As seen in FIG. 2, over a lower press platen 32, pre-heated to 200° C., a carbon steel press frame 34 (having interior dimensions of 325 mm×325 mm×50 mm) was placed to hold the treated wood chips.

Separately, a 1 mm thick, clean, solvent-wiped lower caul press plate 36 made from carbon steel was placed in press frame 34, so that it would rest on the heated lower press platen 32.

An uncompressed lignocellulosic material mat 38 was formed, generally with the dimensions of 325 mm×325 mm×50 mm by placing 1000 g of the treated wood chips 20 inside the press frame 34, and onto the lower caul press plate 36.

A hydraulic press 40 which was modified in such a way that an upper caul platen 42 with the dimensions of 300×300 mm×40 mm was fixed to a heated upper press platen 44, and this was also heated to a temperature of 200° C.

Prior to pressing, a second carbon steel caul plate 46 was placed on the lignocellulosic mat 38.

Within 20 seconds of placing the lignocellulosic mat 38 into the press frame 34, the hydraulic press 40 was activated so as to move the lower press platen 32 upwards in the direction of the arrow shown, and thus result in forcing upper caul platen 42 to be inserted into steel press frame 34, and thereby press second carbon steel caul plate 46 down under pressure, onto lignocellulosic mat 38. The lignocellulosic mat 38 was thereby consolidated to a thickness of 9 mm, and held at that thickness for 120 seconds at a temperature of 200° C., and at a specific pressure of 2.45 MPa, between the upper (46) and lower (36) mild carbon steel caul plates.

Later, after 10 seconds of decompression, the press was opened to provide a resultant pressed board, with both the upper and lower carbon steel caul plates, remaining on the lower platen, on each side of compressed lignocellulosic mat 38. As a result of the pressing operation, the lignocellulosic mat 38 of FIG. 2 was compressed, and the resin system was cured, in order to form an OSB panel 50 having a thickness of 9 mm, as shown in FIG. 3.The upper and lower caul plates were easily removed from panel 50 without applying any force, and there was no damage to the resultant pressed board panel 50 caused by sticking.

This pressing process was then repeated several times with additional mats of the same lignocellulosic material and resins, without any sticking to the upper and lower carbon steel caul plates.

### Comparative Example 1

As comparison the experiment of example 2 was repeated using no surface modifier material blended with the polyol prior to reaction with the polymeric di-isocyanate resin. Consequently, 1 part of Pluracol 492, which was the polyol used in Example 2, was used and mixed with 6 parts of PMDI. Again, a PMDI to wood chip ratio of 6 parts to 100 parts was used to illustrate a high PMDI concentration and its effect on sticking.

Following the pressing instructions given above, the resulting board did not release from the upper and lower caul plates. In fact, the board could not be removed from the upper caul platen without significant damage or destruction of the board.

### Example3

### Additional Pressed Panels

3 kg of air dry Aspen chips with a moisture content of approximately 6.5% were blended with a mixture of 180 g of Covestro Mondur MR Light PMDI and 30 g of a pre-mixed blend of 15 g zinc ricinoleate and 15 g of Dow XD-1421, by air atomized spray application in a 60 litre Lodige plough blender.

As in Example 2, over the pre-heated lower press platen, a carbon steel frame with a interior dimensions measuring 325 mm×325 mm×50 mm was placed to hold the treated wood chips. In this example though, a 1 mm thick, clean, solvent wiped caul press plate made from stainless steel was placed in the press frame onto the heated lower press platen.

A mat was formed with the dimensions of 300 mm×300 mm by using 1000 g of the treated wood chips inside the press frame.

Prior to pressing, a second stainless steel caul plate was placed on the mat.

Within 20 seconds the press was closed and the mat was consolidated to a thickness of 9 mm for 120 seconds at a temperature of 200° C. and a specific pressure of 2.45 MPa, between the upper and lower stainless steel caul plates.

After 10 seconds decompression the press opened and the board remained on the lower platen. The upper and lower stainless steel caul plates were both easily removed without applying of force. This process was repeated several times without any sticking to the upper and lower stainless steel caul plates.

### Comparative Example 2

For comparison, the experiment of example 3 was repeated using no surface modifying agent blended with the polyol prior to reaction with the same polymeric di-isocyanate resin. In this example, 1 part of the same polyol, Dow XD-1421, was again used to 6 parts of PMDI. Again, a PMDI to wood chip ratio of 6 parts to 100 parts was used to illustrate a high PMDI concentration and its effect on sticking.

Following the pressing instructions given above, the resulting board did not release from the upper and lower stainless steel caul plates. In fact, the board could not be removed from the upper caul platen without significant damage or destruction of the board.

### Example4

### Further Pressed Panels

3 kg of air dry Aspen chips with a moisture content of approximately 6.5% were blended with a mixture of 90 g of BASF Lupranate M PMDI and 30 g of a pre-mixed blend of 10 g of calcium stearate and 20 g of castor oil, by air atomized spray application in a 60 litre Lodige plough blender. In this example, a PMDI to wood chip ratio of 100 to 3, by weight, was used to show a lower PMDI to wood chip ratio. The amount of surface modifying agent in the surface modifying agent polyol composition was also reduced to a level of 33% by weight, and thus provide a polyol to calcium stearate ratio of 2:1, by weight.

As in Example 2, over the pre-heated lower press platen, a carbon steel frame with a interior dimensions measuring 325 mm×325 mm×50 mm was placed to hold the treated wood chips.

In this example, a 1 mm thick, clean, solvent wiped caul press plate made from aluminum was placed in the press frame onto the heated lower press platen.

Again, a mat was formed with the dimensions of 300 mm×300 mm by using 1000 g of the treated wood chips inside the press frame.

Prior to pressing, a second aluminum caul plate was placed on the mat.

Within 20 seconds the press was closed and the mat was consolidated to a thickness of 9 mm for 120 seconds at a temperature of 200° C. and a specific pressure of 2.45 MPa, between the upper and lower aluminum caul plates.

After 10 seconds decompression the press opened and the board remained on the lower platen. The upper and lower caul plates were easily removed from the aluminum caul plates, without applying of force. This process was repeated several times without any sticking to the upper and lower aluminum caul plates.

### Comparative Example 3

As comparison the experiment of example 4 was repeated using no surface modifying agent blended with the polyol prior to reaction with the same polymeric di-isocyanate resin. In this example, 1 part of the same polyol, castor oil, was mixed with 3 parts of PMDI. As such, for this example, a PMDI to wood chip ratio of 3 parts to 100 parts was used. Following the pressing instructions given above, the resulting board did not release from the upper and lower aluminum caul plates. In fact, the board could not be removed from the upper caul platen without significant damage or destruction of the board.

Thus, it is apparent that there has been provided, in accordance with the present invention, a surface modifying agent for use in the production of lignocellulosic panels, which fully satisfies the goals, objects, and advantages set forth hereinbefore. Therefore, having described specific embodiments of the present invention, it will be understood that alternatives, modifications and variations thereof may be suggested to those skilled in the art, and that it is intended that the present specification embrace all such alternatives, modifications and variations as fall within the scope of the appended claims.

Additionally, for clarity and unless otherwise stated, the word “comprise” and variations of the word such as “comprising” and “comprises”, when used in the description and claims of the present specification, is not intended to exclude other additives, components, integers or steps. Further, the invention illustratively disclosed herein suitably may be practiced in the absence of any element which is not specifically disclosed herein.

Moreover, words such as “substantially” or “essentially”, when used with an adjective or adverb is intended to enhance the scope of the particular characteristic; e.g., substantially planar is intended to mean planar, nearly planar and/or exhibiting characteristics associated with a planar element.

Further, use of the terms “he”, “him”, or “his”, is not intended to be specifically directed to persons of the masculine gender, and could easily be read as “she”, “her”, or “hers”, respectively.

Also, while this discussion has addressed prior art known to the inventor, it is not an admission that all art discussed is citable against the present application.

1. A surface modifying agent polyol composition for use in the production of a polyurethane based lignocellulosic panel, which composition comprises a mixture of a polyol, and a surface modifying agent, wherein said surface modifying agent is a carboxylate.

2-64. (canceled)

65. The composition as claimed in claim 1 wherein said surface modifying agent has the formula (I), namely: 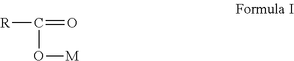
wherein:
metal (M) is a metal selected from the group consisting of Group 1A, 2A, 4B, 4A, 1B, 2B and 8 of the Periodic Table of Elements; and
R is a saturated or unsaturated hydrocarbon.

66. The composition as claimed in claim 65 wherein R is a straight chain or branched chain, saturated or unsaturated aliphatic hydrocarbon, or wherein R is a cycloalkyl radical.

67. The composition as claimed in claim 65 wherein R is, or includes, a primary, secondary or tertiary alcohol, and has a hydroxyl functionality of between 1 and 5.

68. The composition as claimed in claim 65 wherein R has between 10 to 25 carbon atoms.

69. The composition as claimed in claim 65 wherein said carboxylate is the reaction product of a metal-containing material together with an organic acid.

70. The composition as claimed in claim 69 wherein said carboxylate is a metal carboxylate, and wherein said organic acid is Stearic acid, Lauric acid, Myristic acid, Palmitic acid, Stearic acid, Oleic acid, Ricinoleic Acid, Linoleic acid, Linolenic acid, Hydroxypentanoic acid, Dihydroxybutanoic acid, Dihyroxybenzoic acid, Glycolic acid, Lactic acid, Tartaric acid, Citric acid, or Malic acid, and wherein M in formula 1 is sodium, potassium, magnesium, lithium, calcium, titanium, tin, lead, copper, silver, zinc, cadmium, iron, cobalt, nickel, or platinum.

71. The composition as claimed in claim 70 wherein said metal carboxylate is zinc stearate, magnesium stearate, lithium stearate, calcium stearate or cobalt stearate.

72. The composition as claimed in claim 1 wherein said composition comprises between 25 and 75%, by weight of said surface modifying agent.

73. The composition as claimed in claim 1 wherein said surface modifying agent is a metal carboxylate, and said composition comprises a mixture of equal parts, by weight, of said metal carboxylate and an aliphatic or aromatic polyol.

74. The composition as claimed in claim 1 wherein said polyol is a polyester, polyether, or caprolactone-based polyols, is liquid at room temperature, and has a molecular weight of between 400 and 4500.

75. The composition as claimed in claim 74 wherein said polyol has an isocyanate reaction functionality of between 2 and 4.

76. The composition as claimed in claim 1 wherein said polyol is glycerol, 3-(2-hydroxyethoxy)-1,2-propanediol, 3-(2-hydroxypropoxy)-1,2-propanediol, 2,4-dimethyl-2-(2-hydroxyethoxy)-methylpentanediol-1,5, 1,2,6-hexanetriol, or 1,1,1,-trimethylolpropane, or wherein said polyol is prepared by reacting ethylene oxide (EO), propylene oxide (PO) or butylene oxide (BO) with 1,1,1-tris[(2-hydroxyethoxy)methyl]ethane, 1,1,1tris-[(2-hydroxypropoxy)methyl]propane, triethanolamine, triisopropanolamine, pyrogallol or phloroglucinol, in order to form a chain-extended polyol.

77. The composition as claimed in claim 1 wherein said polyol is, or comprises castor oil, a soy-based polyol, or wherein said polyol is a polybutadiene resin.

78. An isocyanate-containing mixture for use in production of a polyurethane based lignocellulosic panel, which mixture comprises an isocyanate resin in admixture with a surface modifying agent polyol composition as defined in claim 1.

79. The mixture as claimed in claim 78 wherein said isocyanate binder resin is diphenylmethane diisocyanate or is a mixture of methylene bridged polyphenyl polyisocyanates containing diisocyanates, triisocyanates and polyisocyanates, or is a polymeric mixture of methylene bridged polyphenyl polyisocyanates (PMDI) containing diisocyanate, triisocyanate and higher functionality polyisocyanates.

80. The mixture as claimed in claim 79 wherein said PMDI has an isocyanate content of between 20%-35%, and has an functionality range of between 2.5 and 2.9.

81. The mixture as claimed in claim 78 comprising between 80 to 65% isocyanate resin, and between 20 to 35% of said surface modifying agent polyol composition, by weight.

82. The mixture as claimed in claim 81 wherein the ratio of isocyanate resin to the surface modifying agent polyol composition ranges from an isocyanate resin to surface modifying polyol composition ratio of from about 3:1 to about 4:1, by weight.

83. A lignocellulosic panel comprising a compressed lignocellulosic mat of a lignocellulosic material which material has been blended with an isocyanate mixture, and wherein said isocyanate mixture is a mixture as claimed in claim 78.

84. The panel as claimed in claim 83 wherein said lignocellulosic material is selected from the group consisting of wood strands, wood chips, wood fibres, wood shavings, wood veneers, wood wool, cork, bark, sawdust, waste products of the wood working industry, paper, bagasse, straw, flax, sisal, hemp, rushes, reeds, rice hulls, husks, grass, and nutshells, and wherein said panel has a weight ratio of isocyanate resin to lignocellulosic material in the range of 1.0:100 to 10:100.

85. The panel as claimed in claim 84 wherein said panel is an MDF panel, an HDF panel, a particleboard panel, plywood, or an OSB panel.

86. A method for the production of a lignocellulosic panel or body comprising:
preparing an isocyanate-containing mixture as claimed in claim 78, as a final resin mixture;
spraying said final resin mixture onto a lignocellulosic material so as to produce a sprayed mat of lignocellulosic material;
compressing said sprayed mat of lignocellulosic material in a press, at pressures of between 1 to 8 MPa specific pressure in a press heated to a temperature of between 150° C. to 220° C., so as to form a cured lignocellulosic panel; and
removing said cured lignocellulosic panel from said press.
